(19) United States
(12) Patent Application Publication
(10) Pub. No.: US 2013/0247228 A1
(43) Pub. Date: Sep. 19, 2013

(54) METHOD, SYSTEM AND SERVER FOR DIGITAL RIGHT MANAGEMENT

(71) Applicants: BEIJING FOUNDER APABI TECHNOLOGY LTD., Beijing (CN); PEKING UNIVERSITY FOUNDER GROUP CO., LTD., Beijing (CN)

(72) Inventors: Haitao WANG, Beijing (CN); Ke HUANG, Beijing (CN); Fengrui ZUO, Beijing (CN)

(73) Assignees: BEIJING FOUNDER APABI TECHNOLOGY LTD., Beijing (CN); PEKING UNIVERSITY FOUNDER GROUP CO., LTD., Beijing (CN)

(21) Appl. No.: 13/893,156

(22) Filed: May 13, 2013

Related U.S. Application Data
(63) Continuation of application No. PCT/CN2012/086463, filed on Dec. 12, 2012.

(30) Foreign Application Priority Data
Nov. 23, 2011 (CN) 201110376756.2

(51) Int. Cl. G06F 21/10

(52) U.S. Cl. CPC G06F 21/10
USPC 726/29

(57) ABSTRACT

This application discloses methods, systems, and servers for digital right management. One such method may include the steps of: combining content of multiple digital files selected by a user into a new digital file; encrypting the new digital file and generating authorization information according to a key used in the encryption and information of a client where the user logs in; and transmitting the authorization information to the client to instruct the client to use the new digital file based on the authorization information. In some embodiments, contents of multiple digital files selected by a user may be combined into a new digital file, and authorization information for the new digital file may be transmitted to the client, thus achieving authorization for digital works from multiple sources.

### RELATED APPLICATION(S)

This application is a continuation application of International Application No. PCT/CN2012/086463, filed on Dec. 12, 2012, which claims priority to Chinese Patent Application No. 201110376756.2 filed with the Chinese Patent Office on Nov. 23, 2011, and entitled “Method, System and Server for Digital Rights Management,” both of which are herein incorporated by reference in their entirety.

### FIELD OF THE INVENTION

The present application relates to the field of digital right protection and particularly to methods, systems, and servers for digital right management.

### BACKGROUND OF THE INVENTION

With the development of network technology and digital publishing technology, and the popularity of various terminal servers, the demand for digital content has increased significantly.

In a typical application, digital content works are often authorized based on the same source, lacking the support for personalized use by a user. Authorizing the digital content works by the same source cannot achieve detailed right management and usage control of the digital content works. Therefore, such method cannot satisfy the user's demand for an application for using digital content works from multiple sources. In order to meet such a demand for personalization, fine-tuned copyright protection of the digital content works from multiple sources is required.

Copyright protection solutions that have been proposed in the industry often fall into two categories. One category relates to an encryption strategy in which a dedicated file format is adopted and content with different privileges are divided into pages in view of the features of the format. The other category is directed to encrypt and store a document as a whole, to divide the document only logically into pages, and to perform range control of the document in a software layer during the usage stage. The two categories of solutions, however, can only authorize works from a single source per page and cannot authorize works from multiple sources.

In sum, it is difficult for existing digital right management methods to authorize works from multiple sources.

### SUMMARY OF THE INVENTION

Embodiments of the invention may involve methods, systems, and servers for digital right management. The application may be used to address the problem that authorization can not be made for digital works from multiple sources in digital right management.

Some embodiments of the invention involve a method for digital right management. The method comprises: combining, by a server, content of multiple digital files selected by a user into a new digital file; encrypting, by the server, the new digital file and generating authorization information according to a key used in the encryption and information of a client where the user logs in; and transmitting, by the server, the authorization information to the client to instruct the client to use the new digital file based on the authorization information.

Some embodiments of the invention involve another method for digital right management. The method comprises: combining, by a recombining server, content of multiple digital files selected by a user into a new digital file; transmitting, by the recombining server, a key corresponding to the new digital file to an encrypting server to instruct the encrypting server to encrypt the new digital file using the key, the key being obtained from a granting server; and instructing, by the recombining server, a client where the user logs in to obtain authorization information corresponding to the new digital file through the granting server when the client needs to use the new digital file, wherein the authorization information is generated by the granting server according to the key corresponding to the new digital file and information of the client where the user logs in.

Some embodiments of the invention involve a server for digital right management. The server includes: a combining module configured to combine content of multiple digital files selected by a user into a new digital file; a generating module configured to encrypt the new digital file, and to generate authorization information according to a key used in the encryption and information of a client where the user logs in; and a processing module configured to transmit the authorization information to the client to instruct the client to use the new digital file based on the authorization information.

Some embodiments of the invention involve another server for digital right management. The server includes: a recombining module configured to combine content of multiple digital files selected by a user into a new digital file; a transmitting module configured to transmit a key corresponding to the new digital file to an encrypting server to instruct the encrypting server to encrypt the new digital file using the key, the key being obtained from a granting server; and an instructing module configured to instruct a client where the user logs in to obtain authorization information corresponding to the new digital file through the granting server when the client needs to use the new digital file, wherein the authorization information is generated by the granting server according to the key corresponding to the new digital file and information of the client where the user logs in.

Some embodiments of the invention involve a system for digital right management. The system includes a server and a client. The server is configured to: combine content of multiple digital files selected by a user into a new digital file, to encrypt the new digital file; generate authorization information according to a key used in the encryption and information of a client where the user logs in; and transmit the authorization information to the client. The client is configured to use the new digital file based on the authorization information.

In the embodiments of the invention, content of multiple digital files selected by a user may be combined into a new digital file, and authorization information for the new digital file may be transmitted to the client, thus achieving authorization for digital works from multiple sources. Furthermore, no dedicated digital rights management client may be required, thus improving ease of use.

### BRIEF DESCRIPTION OF THE DRAWINGS

FIG. 1 is a flow chart of an exemplary digital right management method according to some embodiments of the invention;

FIG. 2 is a diagram of an exemplary system for digital right management according to some embodiments of the invention;

FIG. 3 is a diagram of an exemplary server for digital right management according to some embodiments of the invention;

FIG. 4 is a flow chart of another exemplary method for digital right management according to some embodiments of the invention;

FIG. 5 is a diagram of another exemplary system for digital right management according to some embodiments of the invention; and

FIG. 6 is a diagram of another exemplary server for digital right management according to some embodiments of the invention.

### DETAILED DESCRIPTION OF THE EMBODIMENTS

To solve the problem of authorizing digital works from multiple sources in digital right management, some embodiments of the invention may combine contents of multiple digital files selected by a user into a new digital file and transmit authorization information for the new digital file to a client, thereby achieving authorization of digital works from multiple sources.

The embodiments of the invention will be described in greater detail below with reference to the drawings.

As illustrated in FIG. 1, an exemplary method for digital right management according to some embodiments of the invention may include the following steps.

Step 101—A server may combine content of multiple digital files selected by a user into a new digital file.

Step 102—The server may encrypt the new digital file and generate authorization information according to a key used in the encryption and information of a client where the user logs in.

Step 103—The server may transmit the authorization information to the client to instruct the client to use the new digital file based on the authorization information.

In some embodiments, the user can log in to the server through a webpage, the client, etc. The content of the digital files selected by the user may include partial content of the digital files or the entire content of the digital files.

The server may determine the corresponding digital files according to digital file identifiers included in a received recombination message.

The server may determine the content in the digital files selected by the user according to content information bound with the digital file identifiers in the recombination message.

The client may submit the digital content file identifiers selected by the user and the recombination message (e.g., a selected range of page numbers) to the server. The server may locate the files according to the digital content file identifiers (e.g., each page in a digital content file may be identified by a corresponding page number). The server may further search page numbers in the files according to the range of page numbers selected by the user and extract the corresponding page numbers.

In some embodiments, the content information may be a range of page numbers of digital content that can be recombined.

If the multiple digital files selected by the user are encrypted, then the method may further include the following steps.

The server may decrypt the content of each digital file selected by the user respectively by a key corresponding to each digital file.

The decryption process may include an inverse process of the encryption process. For example, in the encryption process, a file can be encrypted by a specific key, and corresponding encryption information may be added at one or more special locations of the file. In the decryption process, the file can be opened by the key, and the corresponding encryption information may be deleted from the file, thereby decrypting the file.

In some embodiments, there may be provided with two types of decryption.

When using the first type, the entire file may be decrypted, as follows.

1. A file key and an encryption scheme of a digital file may be retrieved from the server according to the identifier of the file.

2. The encrypted file may be opened, and the entire encrypted file may be decrypted by the retrieved key and the encryption scheme.

3. Encryption information may be replaced with decryption information, and the security description information in the original encrypted file may be deleted.

When using the second type, only part of the file selected by the user may be decrypted, as follows.

1. A file key and an encryption scheme of a digital file may be retrieved from the server according to the identifier of the file.

2. The encrypted file may be opened, and page numbers may be located to find a range of page numbers.

3. An encrypted part in the specified range of page numbers may be decrypted by the retrieved key and the encryption scheme.

4. The corresponding part of information among encryption information of the encrypted file may be replaced with decryption information, and security description information of the encrypted file may be regenerated.

The page numbers can be located by decrypting the file first and then reading index and page number information. If both the document index and the page number information are stored externally, then the file may not be decrypted but the document index and the page number information can be read directly to locate the page numbers.

The server may first determine content selected by the user in each digital file selected by the user and then buffer this part of the content and decrypt the buffered content by the key corresponding to the digital file.

For example, the user may select pages 1 to 20 in a digital file A and pages 4 to 28 in a digital file B. The server may buffer the pages 1 to 20 in the digital file A and the pages 4 to 28 in the digital file B (e.g., the buffering used herein refers to copying and storing, and the pages 1 to 20 in the digital file A and the pages 4 to 28 in the digital file B may still present in the digital files A and B, respectively, instead of being deleted due to the buffering process). The server may then decrypt the buffered pages 1 to 20 in the digital file A by a key corresponding to the digital file A (e.g., a key used to encrypt the digital file A) and decrypt the buffered pages 4 to 28 in the digital file B by a key corresponding to the digital file B (e.g., a key used to encrypt the digital file B).

The user can further set a combination order when selecting the content of multiple digital files. Accordingly, in step 101, the server may combine the content of multiple digital files into a new digital file based on the combination order selected by the user.

In order to improve the security of the new digital file, in step 102, the server may first generate a key for the new digital file and then encrypt the new digital file using the generated key.

For example, a random number may be generated according to a current time of the server. The current time can be used as an offset to generate a random string having a predetermined number of characters. The random string may be used as a key.

In step 102, after encrypting the new digital file, the server can instruct the client to obtain authorization information including a file identifier corresponding to the new digital file when the client needs to use the new digital file.

If the user needs to obtain the authorization information, then the user can transmit an authorization request to the server through the client. The authorization request may include the file identifier and the information of the client (e.g., local hardware information of the client and other information capable of identifying the client).

The server may determine the corresponding new digital file according to the received file identifier and may further determine the key corresponding to the new digital file (e.g., the key used to encrypt the new digital file). The server may then generate authorization information according to the determined key and the information of the client. The server may transmit the authorization information to the client.

The client can use the new digital file based on the authorization information.

The authorization information may further include a usage privilege (e.g., a read privilege, a print privilege, a text copy privilege, etc.), the unique identifier of the file, the encryption key of the file, check information of the authorization file, etc.

A system for digital right management may be provided based on the method illustrated in FIG. 1. Because the system is to solve a similar problem to the method under a similar principle, reference can be made to the implementations of the method for implementations of the system. A repeated description of the system is therefore omitted.

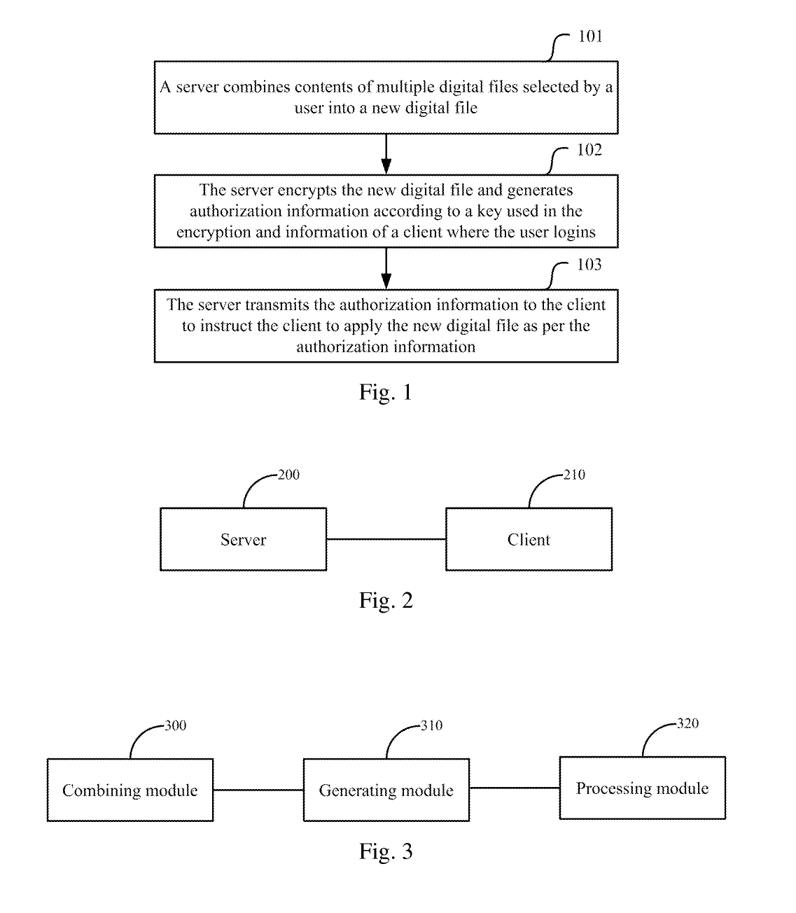

FIG. 2 shows an exemplary system for digital right management according to some embodiments of the invention. The system may include a server 200 and a client 210.

Server 200 may be configured to combine content of multiple digital files selected by a user into a new digital file, to encrypt the new digital file, to generate authorization information according to a key used in the encryption and information of a client where the user logs in, and to transmit the authorization information to the client.

Client 210 may be configured to use the new digital file based on the authorization information.

FIG. 3 shows an exemplary server for digital right management according to some embodiments of the invention. The server may include a combining module 300, a generating module 310, and a processing module 320.

Combining module 300 may be configured to combine content of multiple digital files selected by a user into a new digital file.

Generating module 310 may be configured to encrypt the new digital file, and to generate authorization information according to a key used in the encryption and information of a client where the user logs in.

Processing module 320 may be configured to transmit the authorization information to the client to instruct the client to use the new digital file based on the authorization information.

Combining module 300 may be configured to determine the corresponding digital files according to digital file identifiers included in a received recombination message, and to determine content in the digital files selected by the user according to content information bound with the digital file identifiers in the recombination message.

Combining module 300 may be configured to decrypt content of each digital file selected by the user by a corresponding key associated with each digital file.

Combining module 300 may be configured to determine the content selected by the user in each digital file, to buffer the determined content, and to decrypt the buffered content using the corresponding key associated with each digital file.

Combining module 300 may be configured to combine the content of multiple digital files into a new digital file according to an order selected by the user.

Generating module 310 may be configured to transmit an identifier of the new digital file to the client, to determine the corresponding new digital file according to the identifier of the new digital file included in a received authorization request from the client, and to generate the authorization information according to a key corresponding to the determined new digital file and information of the client included in the authorization request.

The server may include a single server, that is, all the functions of the server described above can be performed by a single server.

Alternatively, the server may include multiple servers, the number of which can be determined as needed in particular applications. In the following example, a three-server embodiment will be described. The three servers include a recombining server, a granting server, and an encrypting server.

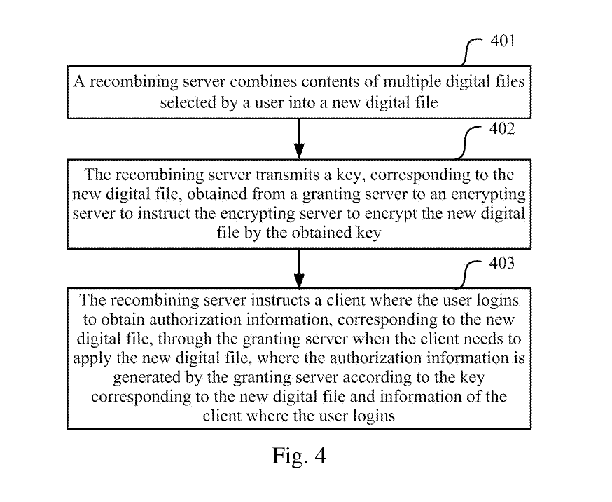

FIG. 4 shows another exemplary method for digital right management according to some embodiments of the invention. The method shown in FIG. 4 may include the following steps.

Step 401—A recombining server may combine content of multiple digital files selected by a user into a new digital file.

Step 402—The recombining server may transmit a key corresponding to the new digital file and obtained from a granting server to an encrypting server to instruct the encrypting server to encrypt the new digital file using the obtained key.

Step 403—The recombining server may instruct a client where the user logs in to obtain authorization information corresponding to the new digital file through the granting server when the client needs to use the new digital file.

The authorization information may be generated by the granting server according to the key corresponding to the new digital file and information of the client where the user logs in.

In some embodiments, the user can log in to the recombining server over a webpage, through the client, etc. The content of the digital files selected by the user can be partial content of the digital files or the entire content of the digital files.

The recombining server may determine the corresponding digital files according to digital file identifiers included in a received recombination message and determine the content in the digital files selected by the user according to content information bound with the digital file identifiers in the recombination message.

In some embodiments, the content information may include a range of page numbers of digital content that can be recombined.

The granting server and the encrypting server may determine an identifier of the new digital file in numerous ways. For example, they may determine an identifier of the new digital file after the digital file is newly added. In another example, the recombining server may generate an identifier of the new digital file after combining the new digital file and transmit the identifier of the new digital file to the granting server and the encrypting server. The recombining server may further put the identifier of the new digital file into a list of digital file identifiers so that the granting server and the encrypting server can determine the identifier of the new digital file from the list. The list of digital file identifiers can be stored in any one of the servers.

If the multiple digital files selected by the user are encrypted, then the method may further include the following steps.

The recombining server may request the granting server for an authorization for the multiple digital files selected by the user.

The granting server may transmit keys corresponding to the multiple digital files to the recombining server.

The recombining server may decrypt the content of each digital file selected by the user, respectively, using the received corresponding keys.

The decryption process may be an inverse process of the encryption process.

For example, the recombining server may first determine content selected by the user in each digital file and then buffer this part of the content (e.g., the digital files can be stored in a specified server, for example, a storing server, the granting server, the encrypting server, etc.). The recombining server may then retrieve the part of the content from the other server and decrypt the buffered content using the corresponding keys to the digital files.

For example, the user may select pages 1 to 20 in a digital file A and pages 4 to 28 in a digital file B. The recombining server may buffer pages 1 to 20 of digital file A and pages 4 to 28 of digital file B (e.g., the buffering used herein refers to copying and storing, and pages 1 to 20 of digital file A and pages 4 to 28 of digital file B may still be present, respectively, in digital files A and B instead of being deleted due to the buffering process). The recombining server may decrypt the buffered pages 1 to 20 of digital file A using a key corresponding to digital file A (e.g., a key used to encrypt digital file A) and decrypt the buffered pages 4 to 28 of digital file B using a key corresponding to digital file B (e.g., a key used to encrypt digital file B).

The user may further set a combination order when selecting the content of multiple digital files. Accordingly, in the step 401, the recombining server may combine the content of the multiple digital files into a new digital file based on the combination order selected by the user.

In order to improve the security of the new digital file, in step 402, the granting server may first generate a key for the new digital file. The recombining server may then transmit the key and the new digital file to the encrypting server, and the encrypting server may encrypt the received new digital file using the received key.

In step 403, the recombining server may instruct the client where the user logs in to obtain the authorization information corresponding to the new digital file through the granting server when the client needs to use the new digital file.

If the user needs to obtain the authorization information, then the user can transmit an authorization request to the granting server through the client. The authorization request may include the file identifier and the information of the client (e.g., local hardware information of the client and other information capable of identifying the client).

The granting server may determine the corresponding new digital file according to the received file identifier and further determine the key corresponding to the new digital file (e.g., the key used to encrypt the new digital file). The granting server may then generate authorization information according to the determined key and the information of the client and transmit the authorization information to the client.

The client can then use the new digital file based on the authorization information.

It is noted that FIG. 4 is merely for the purpose of illustration and the function of the recombining server can alternatively be performed by the granting server and/or the encrypting server, and thus the server can be implemented by only two servers.

A system for digital right management may be provided to perform the method consistent with the example shown in FIG. 4. Because the system is to solve a similar problem under a similar principle to that of the digital right management method shown in FIG. 4, reference can be made to the implementations of the method for implementing the system, and a repeated description of the system will therefore be omitted.

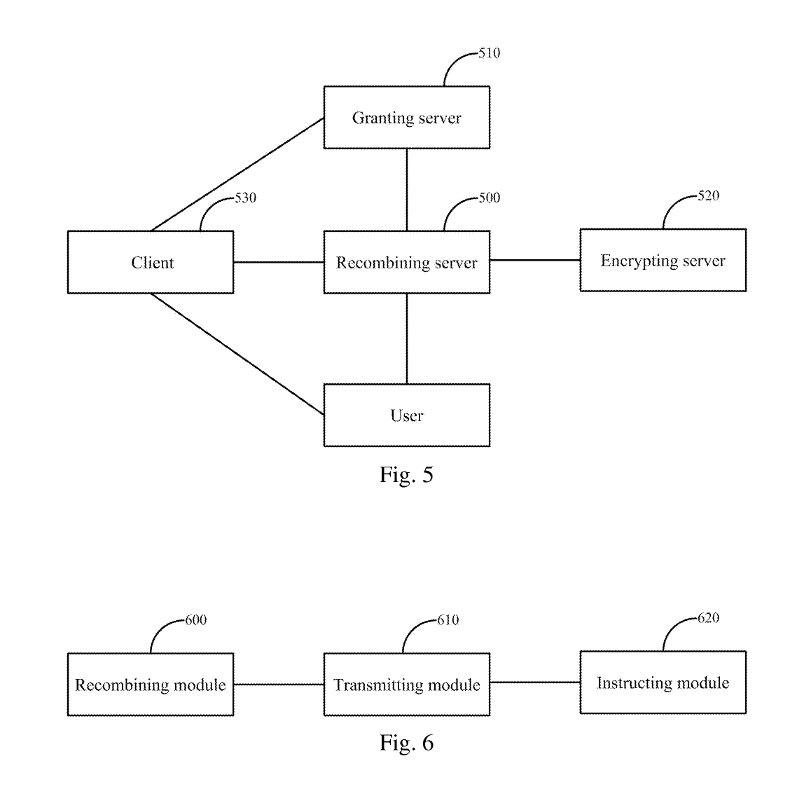

FIG. 5 shows another exemplary system for digital right management according to some embodiments of the invention. The system may include a recombining server 500, a granting server 510, and an encrypting server 520.

The system may further include a client 530.

The system shown in FIG. 5 will be described in detail below by way of an example.

In the example, multiple documents in CEBX format may be recombined and copyright-managed.

For example, there may be provided three files: “Pilgrimage to the West.cebx,” “The Romance of the Three Kingdoms.cebx,” and “A Dream in Red Mansions.cebx.”

A user may select digital content works of interest on the recombining server 500 and determine ranges of page numbers of interest, and combine and sort these ranges. For example, the ranges may include pages 20 to 30 in “Pilgrimage to the West.cebx,” denoted by A, pages 60 to 70 in “The Romance of the Three Kingdoms.cebx,” denoted by B, and pages 90 to 95 in “A Dream in Red Mansions.cebx,” denoted by C. The sort order may be “ABC.”

Recombining server 500 may request granting server 510 for an authorization of only the selected ranges of page numbers according to the selection by the user.

Granting server 510 may generate an authorization to export only the document pages A, B, and C in the three documents.

Recombining server 500 may decrypt the document pages in the specified ranges of page numbers among these documents based on the authorization.

Recombining server 500 may extract the decrypted document pages and recombine them in the order of ABC to form a new file “Classic Novel.cebx.”

Recombining server 500 may request the granting server 510 for a new key.

Granting server 510 may generate a new file key “KRYCY5VRXP1UXZ==” for recombining server 500.

Recombining server 500 may transmit the key and the new file “Classic Novel.cebx” to encrypting server 520.

Encrypting server 520 may encrypt the new file “Classic Novel.cebx” using the key.

Encrypting server 520 may store the new file “Classic Novel.cebx” and the new key in a storing server.

Recombining server 500 may notify client 530 of an available authorization and transmit identifier information of the new file “Classic Novel.cebx” to client 530.

Client 530 may transmit a request including information of client 530 and identifier of the new file “Classic Novel.cebx” to granting server 510.

Granting server 510 may generate authorization information according to the information of client 530 and the key corresponding to the new file “Classic Novel.cebx” and transmit the authorization information to client 530.

Granting server 510 may requests, through the identifier of “Classic Novel.cebx,” the server where “Classic Novel.cebx” is stored for the corresponding key.

Client 530 may download “Classic Novel.cebx.”

Client 530 may use the content of “Classic Novel.cebx” based on the authorization information.

FIG. 6 illustrates another exemplary recombining server for digital right management according to some embodiment of the invention. The server may include a recombining module 600, a transmitting module 610, and an instructing module 620.

Recombining module 600 may be configured to combine content of multiple digital files selected by a user into a new digital file.

Transmitting module 610 may be configured to transmit a key corresponding to the new digital file and obtained from a granting server to an encrypting server to instruct the encrypting server to encrypt the new digital file using the obtained key.

Instructing module 620 may be configured to instruct a client where the user logs in to obtain authorization information corresponding to the new digital file through the granting server when the client needs to use the new digital file.

The authorization information may be generated by the granting server according to the key corresponding to the new digital file and information of the client where the user logs in.

Recombining module 600 may determine the corresponding digital files according to digital file identifiers included in a received recombination message and determine content in the digital files selected by the user according to content information bound with the digital file identifiers in the recombination message.

Recombining module 600 may request the granting server for an authorization for the multiple digital files selected by the user and decrypt the content of each digital file using the received keys corresponding to the digital files.

Recombining module 600 may determine content selected by the user in each digital file and buffer the determined contents. Recombining module 600 may request the granting server for an authorization for the multiple digital files selected by the user and decrypt the buffered content using the received keys corresponding to the digital files.

Recombining module 600 may combine the content of the multiple digital files into a new digital file in an order selected by the user.

Those skilled in the art shall appreciate that the embodiments of the invention can be embodied as a method, a system, or a computer program product. Therefore the invention can be embodied in the form of an all-hardware embodiment, an all-software embodiment or an embodiment of software and hardware in combination. Furthermore, the invention can be embodied in the form of a computer program product embodied in one or more computer useable storage mediums (including but not limited to a disk memory, a CD-ROM, an optical memory, etc.) in which computer useable program codes are contained.

The invention has been described with reference to flow charts and/or block diagrams of the method, the device (system), and the computer program product according to the embodiments of the invention. It shall be appreciated that respective flows and/or blocks in the flow charts and/or the block diagrams and combinations of the flows and/or the blocks in the flow charts and/or the block diagrams can be embodied in computer program instructions. These computer program instructions can be loaded onto a general-purpose computer, a specific-purpose computer, an embedded processor, or a processor of another programmable data processing device to produce a machine so that the instructions executed on the computer or the processor of the other programmable data processing device create means for performing the functions specified in the flow(s) of the flow charts and/or the block(s) of the block diagrams.

These computer program instructions can also be stored into a computer readable memory capable of directing the computer or the other programmable data processing device server to operate in a specific manner so that the instructions stored in the computer readable memory create manufactures including instruction means which perform the functions specified in the flow(s) of the flow charts and/or the block(s) of the block diagrams.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow charts and/or the block(s) of the block diagrams.

Although some embodiments of the invention have been disclosed, those skilled in the art benefiting from the underlying inventive concept can make additional modifications and variations to these embodiments. Therefore, the appended claims are intended to be construed as encompassing the disclosed embodiments and all the modifications and variations coming into the scope of the invention.

In the embodiments of the invention, content of multiple digital files selected by a user can be combined into a new digital file, and authorization information for the new digital file may be transmitted to a client, thus achieving authorization for digital works from multiple sources. Furthermore, no dedicated digital rights management client is required, thus improving ease of use.

Evidently those skilled in the art can make various modifications and variations to the invention without departing from the spirit and scope of the invention. Thus the invention is also intended to encompass these modifications and variations thereto so long as these modifications and variations come into the scope of the claims appended to the invention and their equivalents.

1. A method for digital right management, comprising:
combining, by a server, content of multiple digital files selected by a user into a new digital file;
encrypting, by the server, the new digital file and generating authorization information according to a key used in the encryption and information of a client where the user logs in; and
transmitting, by the server, the authorization information to the client to instruct the client to use the new digital file based on the authorization information.

2. The method according to claim 1, further comprising:
determining, by the server, corresponding digital files according to digital file identifiers included in a received recombination message; and
determining, by the server, the content in the digital files selected by the user according to content information bound with the digital file identifiers in the recombination message.

3. The method according to claim 1, further comprising:
determining, by the server, content selected by the user in each digital file selected by the user and buffering the determined content; and
decrypting, by the server, the buffered content using a key corresponding to each digital file selected by the user.

4. The method according to claim 1, wherein combining the content of the multiple digital files into the new digital file comprises:
combining, by the server, the content of the multiple digital files into the new digital file in an order selected by the user.

5. The method according to claim 1, further comprising:
transmitting, by the server, an identifier of the new digital file to the client; and
wherein generating the authorization information comprises:
determining, by the server, a corresponding new digital file according to the identifier of the new digital file included in a received authorization request from the client; and
generating, by the server, the authorization information according to a key corresponding to the determined new digital file and information of the client included in the authorization request.

6. A method for digital rights management, comprising:
combining, by a recombining server, content of multiple digital files selected by a user into a new digital file;
transmitting, by the recombining server, a key corresponding to the new digital file to an encrypting server to instruct the encrypting server to encrypt the new digital file using the key, the key being obtained from a granting server; and
instructing, by the recombining server, a client where the user logs in to obtain authorization information corresponding to the new digital file through the granting server when the client needs to use the new digital file,
wherein the authorization information is generated by the granting server according to the key corresponding to the new digital file and information of the client where the user logs in.

7. The method according to claim 6, further comprising:
determining, by the recombining server, corresponding digital files according to digital file identifiers included in a received recombination message; and
determining, by the recombining server, the content in the digital files selected by the user according to content information bound with the digital file identifiers in the recombination message.

8. The method according to claim 6, further comprising:
determining, by the recombining server, content selected by the user in each digital file selected by the user;
buffering the determined content;
applying, by the recombining server, to the granting server for authorization for the multiple digital files selected by the user; and
decrypting, by the recombining server, the buffered content using received keys corresponding to the multiple digital files.

9. The method according to claim 6, wherein combining the content of the multiple digital files into the new digital file comprises:
combining, by the recombining server, the content of the multiple digital files into the new digital file in an order selected by the user.

10. A server for digital right management, comprising:
a recombining module configured to combine content of multiple digital files selected by a user into a new digital file;
a transmitting module configured to transmit a key corresponding to the new digital file to an encrypting server to instruct the encrypting server to encrypt the new digital file using the key, the key being obtained from a granting server; and
an instructing module configured to instruct a client where the user logs in to obtain authorization information corresponding to the new digital file through the granting server when the client needs to use the new digital file,
wherein the authorization information is generated by the granting server according to the key corresponding to the new digital file and information of the client where the user logs in.
